(19) United States
(12) Patent Application Publication
(10) Pub. No.: US 2012/0110339 A1
(43) Pub. Date: May 3, 2012

(54) Security Software For Vector File Format Data

(75) Inventors: Calvin Reed, Whitesboro, NY (US); Mark Kozak, Deerfield, NY (US); Brock Adam McCarty, Boulder, CO (US)

(73) Assignee: Par Technology Corporation, New Hartford, NY (US)

(21) Appl. No.: 12/917,442

(22) Filed: Nov. 1, 2010

(51) Int. Cl. H04L 9/32; G06F 21/00

(52) U.S. Cl. 713/185; 726/19

(57) ABSTRACT

Systems and/or methods where a file requires an associated token to be accessed (see DEFINITIONS section) by the software used to access the file and that the token effectively requires that: (i) a particular authorized copy (or subset of authorized copies) of the software is being used to access the file; and (ii) that the authorized software is being run on an authorized hardware set (for example, organizational server computer). In at least some preferred embodiments, the files are specifically vector file format data files (“vffdf's”). In at least some preferred embodiments: (i) the token associated with the file is called a public token; (ii) the authorized software copy includes a private token; (iii) the file is encrypted; and (iv) the public and private tokens must sufficiently correspond in order for the file to be decrypted and thereby accessed. In at least some preferred embodiments, files that have an associated token cannot be accessed unless each licensing condition of a set of licensing (see DEFINITION of “license”) conditions, including at least one licensing condition is met, such that the use of the software on the file bearing the token is considered to be authorized. If the licensing conditions are not all met, then the software may or may not still be allowed to process files that do not bear a token according to the present invention.

### BACKGROUND OF THE INVENTION

1. Field of the Invention

The present invention relates to computer systems for processing vector file format data (see DEFINITIONS section) and more particularly to computer software that provides security for vector file format data.

2. Description of the Related Art

Vector file format data is a known way of creating, storing, organizing and using data to make images and describe geometries. One example of a vector file format data is the Geographical Information System (“GIS”) format. One example of software that uses GIS data is ArcGis (sold through http://www.esri.com/software/arcgis/index.html; the name “ArcGIS may subject to trademark rights in various jurisdictions throughout the world). ESRI shapefiles (or simply “shapefiles”) are an example of vector file format data. Shapefiles are typically used to spatially describe geometries using points, lines, polylines and polygons.

US patent application 2010/0114941 (“941 VonKaenel”) discloses software for providing access to spatial data. 941 VonKaenel primarily deals with the fusion of information from different layers and the production of a single, coherent image of vector file format data. The 941 VonKaenel software attempts to facilitate the visualization a large volume of spatial data. VonKaenel is describing an enterprise architecture for the integration of spatial and non-spatial data and billing of the use of the data. Security is applied to the system as a whole by limiting access to the server that the data resides on. 941 VonKaenel's approach renders the data and serves images to a client via secure channels, as opposed to securing vector file format data files themselves. In the system of 941 VonKaenel, the entire set of GIS functionality is not available to an authorized end user.

Paragraph 0545 of 941 VonKaenel discloses the use of registration, in the sense of username/password, to authenticate access into the system, track purchases of data, and store credit card information. However, this username/password feature of 941 VonKaenel does not determine authorization level as far as access to a shapefile goes.

Paragraph 0937 of VonKaenel discloses avoidance of the use a floating license manager by controlling the number of user IDs generated. For example, if 20 user IDs are created, up to 20 people could access the data server at the same time. the 941 VonKaenel system employs user roles to determine server functionality to be available, and geographic limits on the data.

Paragraph 0982 of 941 VonKaenel discloses an online transaction system used to essentially buy access to the spatial data. Payment must be made in order to acquire authorization to access an on line server and thereby access the spatial data. It is noted that it is the transactional process that is subject to payment and authorization in 941 VonKaenel, and not the spatial data itself.

Paragraph 1109 of 941 VonKaenel discloses a web server of data, an archive of the data, back-up capability for the data and restore capability for the data. To ensure that the backed-up (archived) data is secure while in storage, it is encrypted using industry best practices. However, VonKaenel does not disclose that this encryption disclosed at paragraph 1109 would or could apply to vector file format data files when they are in their normal, end user accessible state. This encryption of paragraph 1109 does not control end user access to the data based on the user's authorization status (for example, licensed status).

Paragraphs 861 and 894 of 941 VonKaenel disclose the use of a visual watermark on top of images and maps. 941 VonKaenel's watermark can be seen during the visualization of the data. More specifically, when using the 941 VonKaenel software, the enterprise spatial system watermark serves to prevent the user from saving a file from a UI screen display. When using the 941 VonKaenel software, users are allowed to see maps in a sort of limited use, preview mode. These preview maps may be generated by vector file format data, but the users are not supposed to actually have access to the underlying files themselves until purchase. The 941 VonKaenel watermark allows the users to preview the map without being able to generate a vector file format data file corresponding to what they are seeing on their display (for example, display on a computer monitor). 941 VonKaenel discloses that its visual watermark is removed when the user purchases the files upon which the preview map is based.

US patent application 2007/0147655 (“Chuang”) discloses software for protecting the content of vector graphics formats. Chuang is primarily concerned with vector graphic processing through the manipulation of pixel data. A watermark image is used in Chuang to hide a part of the key that is used to decrypt the pixel data and restore the data to its original visual quality. The watermark in Chuang would typically be a company logo or some other pixel based information. In other words, Chuang uses its watermark to accomplish pixel based hiding. It is noted that 655 Chuang does not use code-based watermarking (or code-hash-based watermarking) because its watermark is applied to data of images and the executable code portion of a file.

US patent application 2009/0089078 (“Bursey”) discloses an enterprise geospatial intelligence service oriented architecture. The Bursey system creates a web service to autonomously take geospatial data and create a tailored derivative product based on a customer's parameters. At paragraph 0293, Bursey discloses that: (i) a base collection of technologies, policies and tradecraft facilitates the availability of and access to spatial data within a defined enterprise; and (ii) this base collection is implemented within an Oracle Enterprise 11 g Spatial module; (iii) the Oracle Enterprise 11 g Spatial module is an enterprise capable commercial off-the-shelf database that the National Geospatial-Intelligence Agency has already licensed across the enterprise; (iv) the Spatial module allows geospatial data to be stored as native data types within the database; and (v) this technique of storage as native types spatially enables the database to allow spatial operations to be executed within the database itself, rather than requiring a separate application. In Bursey, there is no disclosure of licensing the data, as such, or preventing the data from going to unintended audiences. Oracle Enterprise 11g Spatial is a relational database and does not deal directly with vector file format data files. The ability to import vector files such as shapefiles into the Oracle Enterprise 11g Spatial database exists. There may also exist a method to export data from the Oracle Enterprise 11g Spatial database back out to a vector file format data file, such as a shapefile.

Description of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, may not reflect subject matter developed early enough in time and/or may not be sufficiently enabling so as to amount to prior art for patent law purposes. To the extent that specific publications are discussed above in this Description of the Related Art Section, they are all hereby incorporated by reference into this document in their respective entirety(ies).

### BRIEF SUMMARY OF THE INVENTION

The present invention is directed to systems and/or methods where a file requires an associated token to be accessed (see DEFINITIONS section) by the software used to access the file and that the token effectively requires that: (i) a particular authorized copy (or subset of authorized copies) of the software is being used to access the file; and (ii) that the authorized software is being run on an authorized hardware set (for example, organizational server computer). In at least some preferred embodiments, the files are specifically vector file format data files (“vffdf's”). In at least some preferred embodiments: (i) the token associated with the file is called a public token; (ii) the authorized software copy includes a private token; (iii) the file is encrypted; and (iv) the public and private tokens must sufficiently correspond in order for the file to be decrypted and thereby accessed. In at least some preferred embodiments, files that have an associated token cannot be accessed unless each licensing condition of a set of licensing (see DEFINITION of “license”) conditions, including at least one licensing condition is met, such that the use of the software on the file bearing the token is considered to be authorized. If the licensing conditions are not all met, then the software may or may not still be allowed to process files that do not bear a token according to the present invention.

According to an aspect of the present invention, a computer system accesses files. The system includes a set of computer(s) including at least one computer. The set of computers including: a first hardware-identification code, a processing module, and a storage module. The storage module is structured, connected and/or programmed to store a copy of the secured-access software. The processing module is structured, connected and/or programmed to run a copy of the secured-access software. The secured-access software comprises a private token that indicates: (i) an authorized hardware-identification code of computer equipment upon which the secured-access software is authorized to run; and (ii) an identification of the specific copy of the secured-access software that is stored in the storage module. The secured-access software is programmed to receive a public token associated with a first file that is being attempted to be accessed through the secured-access software, with the public token indicating a set of identities of authorized copy(ies), including at least one authorized copy, with the set of identities of authorized copy(ies) corresponding to the specific copy(ies) of the secured-access software with which the first file is authorized to be accessed. The secured-access software is further programmed to check a first condition where the private token is checked against the first hardware-identification code to determine whether the authorized hardware-identification code matches the authorized first-identification code. The secured-access software is further programmed to check a second condition where the private token is checked against the public token to determine whether the identity of the specific copy of the secured-access software stored in the storage module matches at least one of the identities of authorized copy(ies) of the set identities of authorized installation(s) indicated by the public token. The secured-access software is further programmed to allow the first file to be accessed by the secured-access software only if both the first condition and second condition are both met.

According to a further aspect of the present invention, a method is used to access files by a computer system. the computer system includes a first hardware-identification code, a processing module, and a storage module. The method includes the following steps (not necessarily in the following order): (a) providing, on the computer system, secured-access software including a private token that indicates: (i) an authorized hardware-identification code of computer equipment upon which the secured-access software is authorized to run; and (ii) an identification of the specific copy of the secured-access software; (b) receiving, by the secured-access software, a public token associated with a first file that is being attempted to be accessed through the secured-access software, with the public token indicating a set of identities of authorized copy(ies), including at least one authorized copy, with the set of identities of authorized copy(ies) corresponding to the specific copy(ies) of the secured-access software with which the first file is authorized to be accessed; (c) checking, by the secured access software, a first condition where the private token is checked against the first hardware-identification code to determine whether the authorized hardware-identification code matches the authorized first-identification code; (d) checking, by the secured-access software, a second condition where the private token is checked against the public token to determine whether the identity of the specific copy of the secured-access software matches at least one of the identities of authorized copy(ies) of the set of identities of authorized copy(ies) indicated by the public token; and (e) allowing access, by the secured-access software, to the first file only if both the first condition and second condition are determined to be met at the two checking steps.

According to a further aspect of the present invention, a method is used to provide a file for authorized use. The method includes the following steps (not necessarily in the following order): (a) providing the file to a file securing computer; (b) associating, by the file securing computer, the file with a public token including a public decryption key; (c) encrypting, by the file securing computer, the file based at least in part upon public decryption key; and (d) providing the encrypted file and its associated public token to an end user computer. The public token further includes a set of identities of authorized copies of file processing software corresponding to the identities of specific copies by which the file is authorized to be accessed.

### BRIEF DESCRIPTION OF THE DRAWINGS

The present invention will be more fully understood and appreciated by reading the following Detailed Description in conjunction with the accompanying drawings, in which:

FIG. 1 is a schematic view of a first embodiment of a computer system according to the present invention;

FIG. 2 is a schematic view of a removable data storage medium including data according to the present invention;

FIG. 3 is a flowchart of a process according to the present invention;

FIG. 4 is a schematic view of a second embodiment of a computer system according to the present invention;

FIG. 5 is a conceptual overview of the file securing technique of the second embodiment computer system;

FIG. 6 is a schematic view of a portion of the second embodiment computer system;

FIG. 7 is a schematic view of another portion of the second embodiment computer system;

FIG. 8 is a schematic view of another portion of the second embodiment computer system;

FIG. 9 is a schematic view of another portion of the second embodiment computer system;

FIG. 10 is a schematic view of another portion of the second embodiment computer system;

FIG. 11 is a schematic view of another portion of the second embodiment computer system;

FIG. 12 is a schematic view of another portion of the second embodiment computer system; and

FIG. 13 is a schematic view of another portion of the second embodiment computer system.

### DETAILED DESCRIPTION OF THE INVENTION

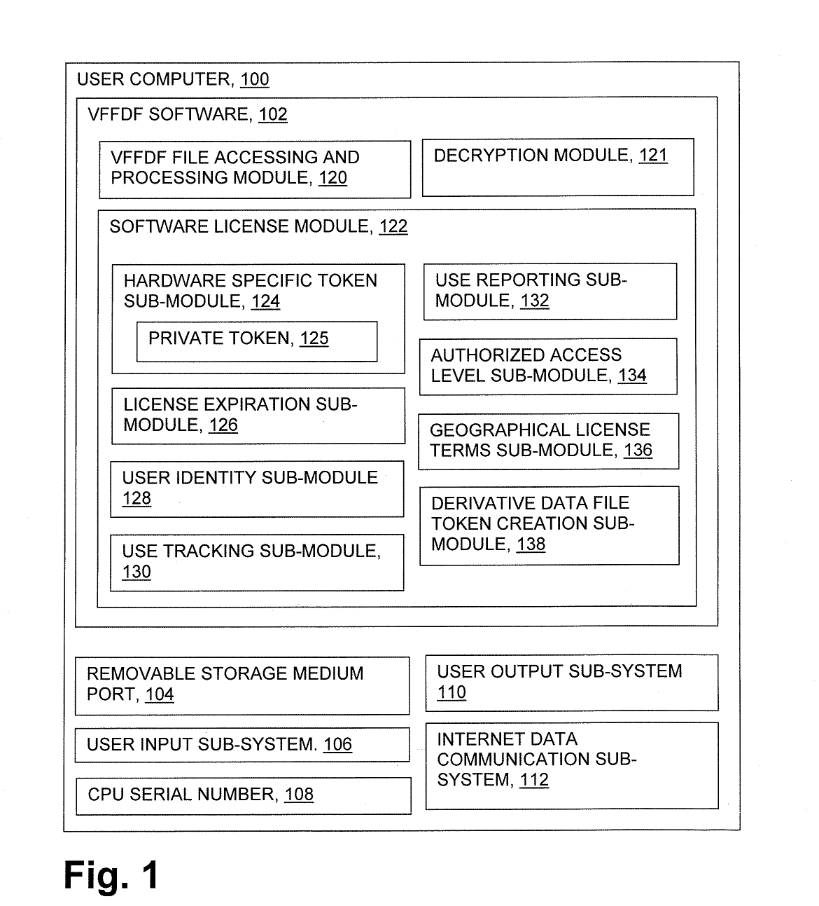

FIG. 1 shows a user computer 100, including: vector file format data file (vffdf) software 102; removable storage medium port 104; user input sub-system 106; CPU serial number data 108; user output sub-system 110; and internet data communication sub-system 112. the vffdf software is used to access and/or process vffdf files, as will be explained in further detail below. The removable storage medium port 104 can read data from a removable storage medium, such as a CD-ROM or a jump drive. The user input sub-system preferably includes a keyboard and a mouse and receives data from the user which (among other things) is used to access and/or process vffdf files. The user output sub-system preferably includes a display, such as an LCD computer monitor. the internet data sub-system is any type of sub-system for communicating data to and/or from the internet, such as a cable modem connection and browser software.

As shown in FIG. 1, software 102 includes: vffdf file accessing and processing module 120; decryption module 121; and software licensing module 122. The vffdf accessing and processing module provides instructions for accessing and processing vffdf files. For example, module 122 can take a decrypted vffdf and display it on the user output system as a visual display for the user. As a further example, module 122 can allow an authorized user to create and/or modify a vffdf through commands entered through the user input system. One example of a conventional vffdf accessing and processing system would be the ArcGIS software used to access and/or process shapefiles.

As shown in FIG. 1, software license module 122 includes: hardware specific token sub-module 124; license expiration sub-module 126; user identity sub-module 128; use tracking sub-module 130; use reporting sub-module 132; authorized access level sub-module 134; geographical license terms sub-module 136; and derivative data file token creation sub-module 138. Hardware specific token sub-module 124 is used to control access to the vffdf software and to vffdf's themselves as will be further explained below. License (see DEFINITIONS section) expiration sub-module 126 specifies the date and time upon which authorization to use the vffdf software ends, as well as any dates/times that the authorized periods for using specific vffdf's will end. This module would not be used in (not necessarily preferred) embodiments of the present invention with perpetual authorization.

User identity sub-module 128 specifies any restrictions on user identity of users that are allowed to run the vffdf software and/or particular vffdf's. It should be understood that any user identity restrictions in the operative license are separate and distinct from restrictions on the identity of hardware used to run the vffdf software. For example, as further explained below, preferred embodiments of the present invention usually will restrict what computer the vffdf is authorized to run upon, but preferred embodiments do not necessarily restrict as to which specific individual people are authorized to run the vffdf software. In many embodiments of the present invention there will be no user identity sub-module because restrictions on user identity are not required. When authorization is restricted with respect to user identity, this can be accomplished, for example, by username/password techniques and/or biometric identity checks.

Use tracking sub-module 130 tracks use of the vffdf software and/or use of specific vffdf's. For example, if the license specifies that he vffdf software is only authorized to view ten (10) vffdf's, then the use tracking sub-module would prevent the viewing of the eleventh attempted vffdf by denying access to the vffdf software, to the eleventh vffdf or both. Many other types of use-based restrictions on authorization are possible, as will be understood by those of skill in the art. Some embodiments of the present invention will include no use based restrictions and no use based tracking.

Use reporting sub-module 132 reports use of the vffdf software and/or specific vffdf's back to other parties through the internet data communication sub-system. For example, it may report denials of access back to the licensor of the software and/or the licensor of a specific vffdf. As a further example, it may report how many times a particular vffdf was accessed back to the licensor of the vffdf so that the licensor can collect a running royalty based on vffdf usage. Not all embodiments of the present invention necessarily include use reporting.

Authorized access level sub-module 134 controls the level of access to the vffdf software and/or to particular vffdf's. For example, a software license may authorize using the vffdf software to view files, but not modify them. One way to enforce this restriction on authorization would be to download the full version of the vffdf software on the restricted hardware set, but then use sub-module 134 to make sure that unauthorized portion of the vffdf software are not accessible to a user of the hardware set. Similarly, there may be different level of use restrictions on individual vffdf's on a vffdf-by-vffdf basis. Not all embodiments of the present invention necessarily include different levels of use for different computers, users and/or vffdf's.

Geographical license terms sub-module 136 implements any geographical restrictions on authorization. For example, if a license specifies that a particular vffdf is only to be used on-site at an organization's facility, then sub-module 136 would prevent the use of this module is GPS tracking indicated that user computer 100 had been removed from the organization's facility. Not all embodiments of the present invention necessarily include the capability of implementing geographical restrictions.

Derivative data file token creation sub-module creates data license files and/or public tokens for data files that are created and/or modified by the user, under conditions that the operative authorization requires the newly-created and/or modified files to have a data license file and/or token. For example, a software license may specify that all vffdf's created and/or modified must be encrypted and must include a public token for decryption. It is sub-module 138 that would create this public token and mandate the encryption. Not all embodiments of the present invention necessarily include the capability of making and/or restricting derivative vffdf's.

The foregoing restrictions or limitations on authorized access to the vffdf software and/or vffdf's is merely exemplary in nature. There may be many other types of restrictions or limitations on authorized access. The preceding paragraphs merely try to give a sense of the wide variety of authorization limitations or restrictions that are possible and that can be implemented by various embodiments of the present invention.

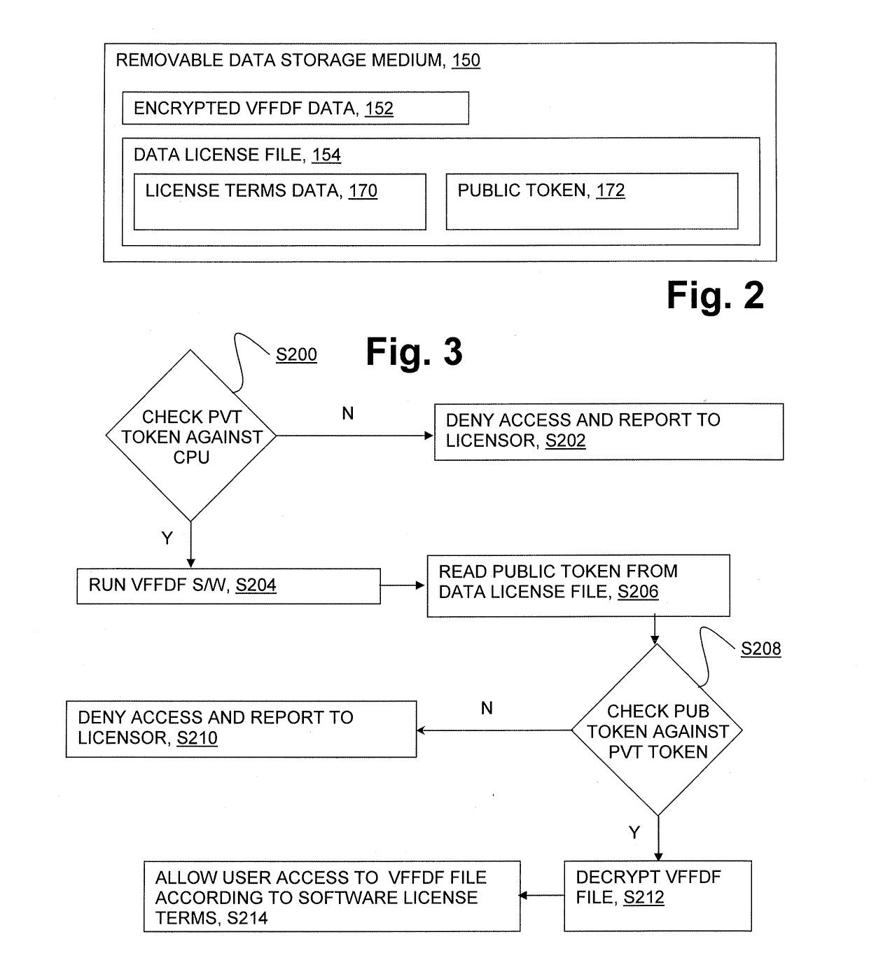

FIG. 2 shows removable data storage medium 150, including: encrypted vffdf data 152; and data license file 154. The data license file includes: license terms data 170; and public token 172. The removable storage medium may be any type of tangible storage medium now known or to be developed in the future, such a CD-ROM or jump drive. In many preferred embodiments of the present invention, Vffdf's will be delivered to the user's computer over data communication networks, such as the internet. This preferred alternative will be further discussed below.

FIG. 3 shows a method for using user computer 100 to access and/or process the vffdf that is on medium 150 in encrypted form. At step S200, private token 125 of the user computer is checked against CPU serial number 108 by hardware specific token sub-module 124 of software license module 122 of vffdf software 102 (see FIG. 1). If private token 125 does not properly correspond to CPU serial number 108, then processing proceeds to step S202, where the user is denied access because it is not running on a computer for which the vffdf software is authorized to be used.

If private token 125 does properly correspond to CPU serial number 108, then processing proceeds to step S204, where the vffdf software begins to run. Processing then proceeds to step S206, where public token 172 (see FIG. 2) is read through removable storage medium port 104 (see FIG. 1). Processing proceeds to step S208, where public token 172 of the vffdf is checked against private token 125 by hardware specific token sub-module 124 of software license module 122 of vffdf software 102 (see FIG. 1). The public token 172 on the medium has been created to correspond to a specific copy of the vffdf software and is not authorized to run on other copies of the vffdf software, even if these other copies happen to have licensed the same vffdf that is stored on tangible medium 150. If public token 172 does not properly correspond to private token 125, then processing proceeds to step S210, where the user is denied access because the particular encrypted copy of the vffdf is not authorized to run on the particular copy of vffdf software 12 that is installed on user computer 100 (see FIG. 1).

If public token 172 does properly correspond to private token 125, then processing proceeds to step S212, where the encrypted vffdf 152 is decrypted using the private token and the public token. Processing proceeds to step S214, where the user is allowed to access and/or process the decrypted vffdf within the restrictions or limitations (if any) imposed by various sub-modules of software license module 122. In this way, superior file security and integrity of licensing arrangements can be provided by the present invention.

While system and method 100, 200 of FIGS. 1 to 3 has been explained in terms of vffdf's (see DEFINITIONS section) or vector file format only data files (see DEFINITIONS section), which is highly preferred, it is possible that the present invention may be applicable to other types of files that have special software for accessing and manipulating them, such as word processing files, raster image files (for example, .jpg files), spreadsheet files, Power Point type files and so on.

A preferred embodiment of the present invention which has been given the name “Secure System,” for convenience of reference purposes, will now be discussed in detail. This detailed discussion will include discussion of many preferable and advantageous features. However, these features and advantages should not be considered mandatory in all embodiments of the present invention because of the inclusion of the feature or advantage in the exemplary Secure System embodiment 300.

I. Secure System Overview

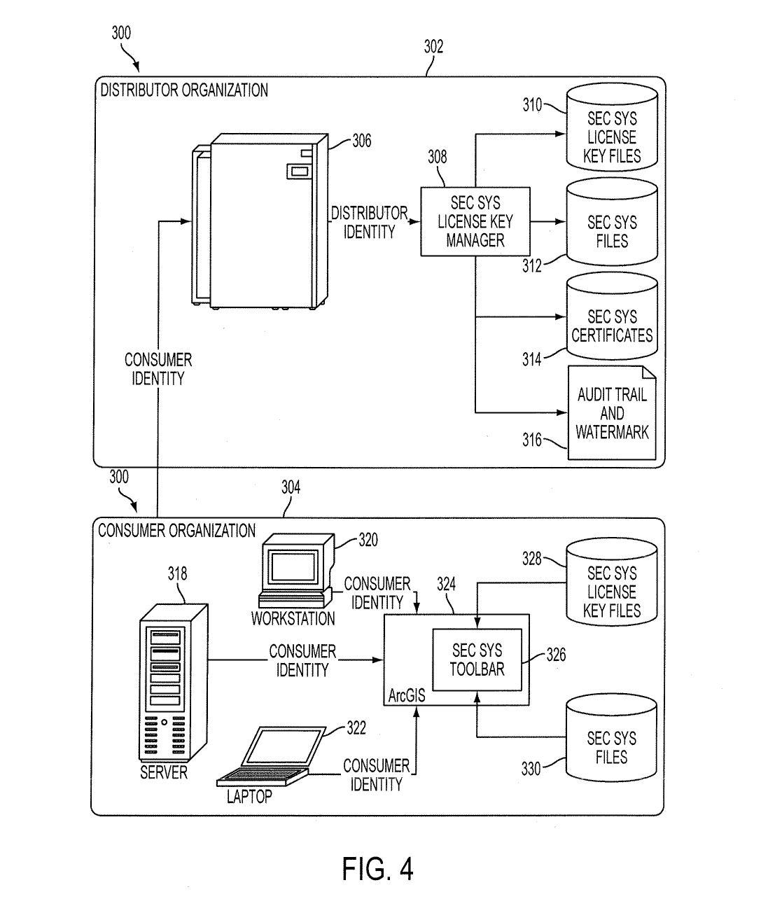

Secure System is a software application that facilitates the timely sharing of GIS information within a secure environment. FIG. 4 shows an embodiment of a networked computer system 300 that uses the Secure System software. As shown in FIG. 4, system 300 includes: distributor organization 302; and consumer organization 304. In preferred embodiments, these organizations 302, 304 are data communication connected (see DEFINITIONS section) by a computer network (not shown, of any type now known or to be developed in the future). In preferred embodiments, various computer components within each of these organizations 302, 304 are data communication connected with each other by a computer network (not shown, of any type now known or to be developed in the future). As further shown in FIG. 4, the distributor organization includes: distributor computer 306; Secure System license key manager 308; Secure System license keyfiles database 310; Secure System files database 312; Secure System certificates database 314; and audit trial & watermark module 316. As shown in FIG. 4, the customer organization includes: server 318; workstation 320; laptop 322; ArcGIS software 324; Secure System toolbar module 326; Secure System license keyfiles database 328; and Secure System files database 330. The Secure System system consists of two major components: (i) The Secure System License Key Manager; and (ii) The Secure System Toolbar.

The Secure System License Key Manager 308: This component resides within the data distributor's organization and provides the mechanism to encrypt GIS feature sets into proprietary formatted Secure System files. Secure System certificates are generated for the encrypted Secure System files. A matching security codes are encoded into both the Secure System file and the corresponding Secure System certificate. The security code that is encoded into the Secure System certificate is one form of what is sometimes referred to herein as a private token. The security code that is encoded into the Secure System file is a form of what is sometimes referred to herein as a public token. To distribute the Secure System file to a data consumer a time-limited, encrypted Secure System license key is generated for the specific consumer organization. The data distributor, upon proper certification of ownership of a Secure System file, may display the encoded code-based watermark, certify the authenticity of the data contained in the Secure System file, and obtain an audit trail of any modifications made to the Secure System file by any of the licensed data consumers.

The Secure System Toolbar 326: This component is an extension to ESRI ArcGIS software 324 and resides between the user and the ArcGIS functionality relating to mathematical vector file format data (see DEFINITIONS section). (ESRI and/or ArcGIS may be subject to trademark rights in various jurisdictions throughout the world, and any references made herein relate to the products and/or services of any trademark owner and such references are not to be taken as references to a generic type of service and/or product.) The Secure System toolbar 326 must be loaded in order to decrypt and load a Secure System file into an ArcGIS document. An active, valid Secure System license key must be present for the Secure System file to be decrypted and loaded. The resulting Secure System feature set resides in memory as a temporary entity. If the Secure System toolbar is removed the Secure System feature sets are removed also. The Secure System toolbar overrides the normal operation of ArcGIS when a Secure System feature set is involved. Any operation on a Secure System feature set results in another Secure System feature set. Newly created Secure System features sets are saved in encrypted Secure System files with the ownership of the originator maintained. An audit trail of any authorized modifications to the Secure System File is maintained.

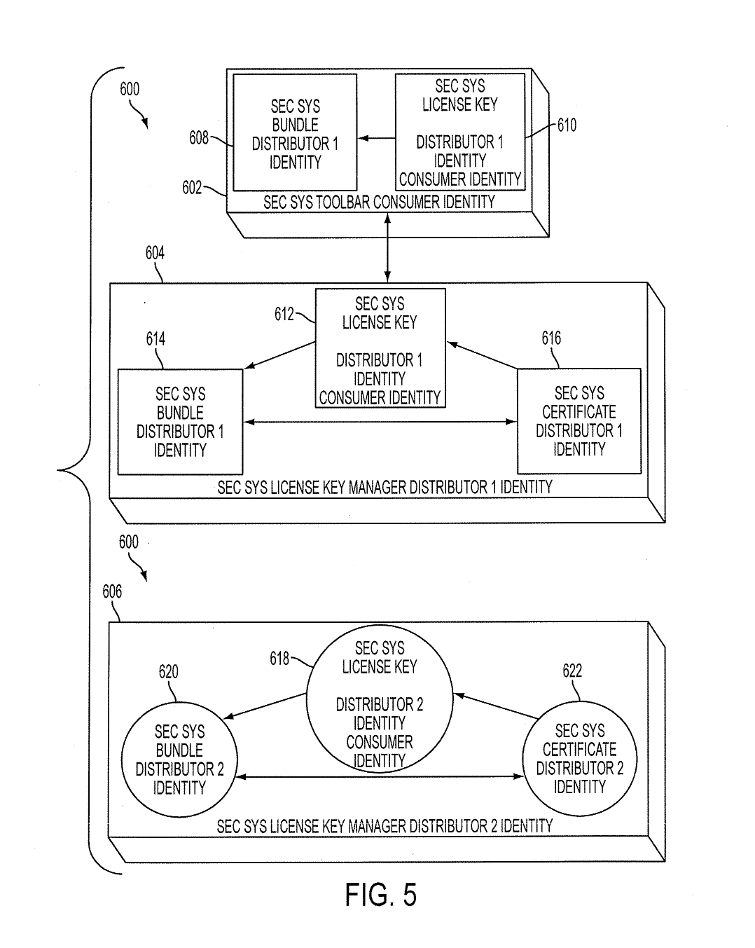

A conceptual overview will now be discussed. The Secure System software assigns a unique identifier to each registered organization 304 that receives the software. This unique identifier is encrypted to protect the user's identity from being forged. The Secure System software is licensed to a specific computer. The user's identity is bound to that computer at the time the Secure System software is installed. The Secure System software installer is keyed to the hardware serial number of the receiving computer and will only install the Secure System software on the computer it was keyed for; therefore, the user's identity, assigned by the Secure System software, is bound to the computer that the Secure System software is installed on. The Secure System toolbar is bound to a data consumer's identify. The Secure System license key is bound to a data distributor's identity. Conceptual overview 600, shown in FIG. 5, provides an illustration of this concept.

As shown in FIG. 5, conceptual overview 600 includes Secure system toolbar consumer identity block 602; Secure System license key manager distributor 1 identity block 604; and Secure System license key manager Distributor 2 identity block 606. Secure System toolbar consumer identity block includes: Secure System bundle distributor 1 identity sub-block 608; and Secure System license key distributor 1 identity consumer identity sub-block 610. Secure System license key manager distributor 1 identity block includes: Secure System license key distributor 1 identity consumer identity sub-block 612; Secure System bundle distributor 1 identity sub-block 614; and Secure System certificate distributor 1 identity 616. Secure System license key manager distributor 2 identity 606 includes: Secure System license key distributor 2 identity consumer identity 618; and Secure System certificate distributor 2 identity 622.

When a distributor creates a bundle of encrypted Secure System files a certificate is also created. The bundle and the certificate are bound to each other by several encrypted fields, including the distributor's identity.

A license key can only be created by the same uniquely registered organization (the licenser) that created the bundle and holds the certificate for the bundle. The license key is bound to the bundle by several encrypted fields, including the distributor's identity. The license key may also be bound to an individual licensee organization by several encrypted fields, including a consumer identity. Optionally, a distributor may elect a username/password authentication rather than utilizing the consumer's identity to restrict access to the encrypted Secure System files.

Only the owner of the source files that are encrypted into the bundle can issue a license key for the bundle because the certificate is bound to the bundle. The certificate is not distributed with the bundle and should be protected by the distributor. If someone obtained the certificate for the bundle and was a registered user of the license key manager, the license key manager would not generate a license key for the bundle because the registered user's identity would not match the identity of the user that created the bundle and corresponding certificate.

In a similar fashion, the Secure System toolbar will not open an encrypted Secure System file if the encrypted distributor's identity contained in the Secure System file does not match the distributor's identity contained in the license key for the Secure System bundle.

The consumer identity and the distributor identity employ a Public Key Infrastructure (PKI). A licensee provides the public key of their consumer identity to a licenser. The Secure System software serves as a registration agent for the consumer and the distributor identities. The Secure System license manager software assigns an encrypted private key and embeds it into the issued software license. The Secure System software license manager also assigns a corresponding public portion o the identity.

A consumer provides the public key of their consumer identity to a distributor. When a Secure System data license is checked for validity, the private key contained in the license must correspond to the private key that is assigned for that consumer's identity by the Secure System toolbar. The secure System certificate that is generated by the Secure System license manager serves as a certificate authority for the distributor's identity.

II. Secure System License Key Manager

The Secure System license key manager provides four major functions as will now be discussed. the first function is the ability to bundle a set of GIS Shapefiles into a single entity. A single Secure System certificate is generated for the set; however, each Shapefile is encrypted separately using a different random seed to initiate the encryption. The second major function is the ability to create a license key file for each unique data consumer of the distributed bundle of Secure System files. The bundle is the entity that is licensed. The third major function is the ability to administer Secure System files, authenticate Secure System files, and reconstruct the custody chain for a Secure System file. The forth major function is the ability to add associated surety codes (that is, a public token) to a Shapefile and authenticate a Shapefile.

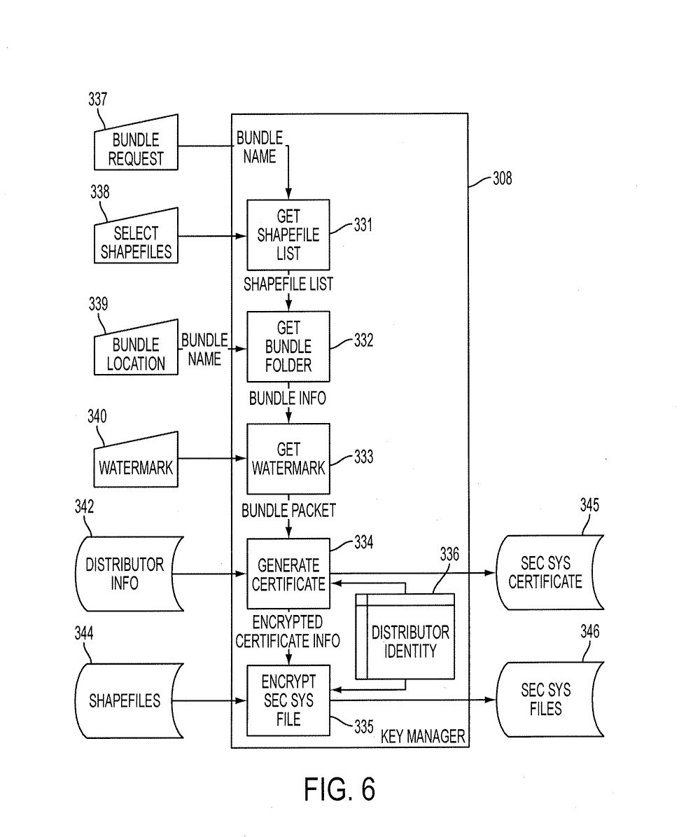

A bundle is the entity that a data distributor licenses for use by one or more data consumers. FIG. 6 provides an illustration of the process for creating a bundle. As shown in FIG. 6, the process of bundle creation makes use of the following modules (see DEFINITIONS section for definition of “module”) to supply input data, perform processing and/or receive output data: get shapefile list 331; get bundle folder 332; get watermark 333; generate certificate 334; encrypt Secure System file 335; distributor identity 336; bundle request 337; select shapefiles 338; bundle location 339; watermark 340; distributor info 342; shapefiles 344; Secure System certificate 345; and Secure System files 346.

When a bundle request is initiated the user is presented with an input file browser for selecting a list of Shapefiles to include in a bundle. For instance, a data distributor might bundle all of the Shapefiles for a specific county, such as roads, parcels, and utilities into a single bundle. Or a data distributor might bundle the parcel data for three separate counties into a tri-county data set. Next the user is presented with an output folder browser to provide the name and location of the resulting bundle. The distributor organization's identity is encoded into each encrypted Secure System file as well as into the Secure System certificate. A unique Secure System certificate is generated for each bundle. The Secure System certificate is not distributed with the Secure System files, but is used by the administration functions to authenticate Secure System files. The certificate employs a one-way encryption involving a random-length, random-generated seed to secure all of the fields of the certificate. Each field is encrypted separately and in various combinations. The combination of the encrypted fields is stored as a random length, continuous code, typically several hundreds characters long. This is done to prevent forging of a Secure System certificate. The distributor's identity, the creation date of the bundle, the creation date of the certificate, and the name and size of each encrypted Secure System file are contained in the certificate.

Each selected Shapefile is converted to a Secure System file. The Secure System files, along with a license key file generated by the key creation function, are distributed to the intended data consumer. Each feature of each Shapefile is preferably encrypted separately, preferably employing a two-way random-length, random-generated seed to initiate the encryption. The points of the shape are encrypted separately from the attributes. Additional fields providing the distributor's identity, the consumer's identity, a custody chain, and the file name and size is encrypted preferably using a one-way encryption, preferably involving a random-length, random-generated seed to secure this information. A private unlocking key is also encrypted. Each field is encrypted separately and in various combinations. The combination of the encrypted fields is stored as a random length, continuous code, typically several hundreds of characters long. This is done to prevent forging of a Secure System file and to facilitate detection of attempt to modify, or otherwise tamper with the Secure System file, by of unauthorized users. Authorized modifications made with the Secure System toolbar are maintained in the custody chain of the Secure System file.

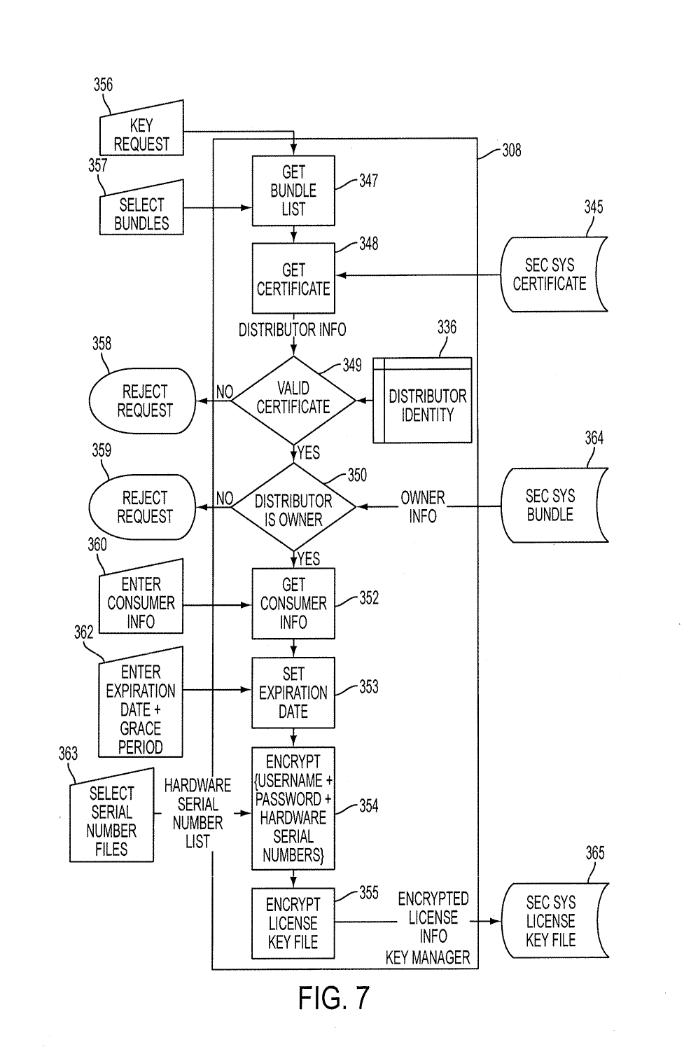

The process of creating Secure System license keys will now be discussed. A license key provides the mechanism for unlocking a Secure System file. A separate license key is provided for each data consumer to whom a set of bundles of Secure System files is distributed. FIG. 7 provides an illustration of the process of creating a license key. As shown in FIG. 7, the process of license key creation makes use of the following modules to supply input data, perform processing and/or receive output data: get bundle list 347; get certificate 348; valid certificate determination 349; distributor is owner determination 350; get consumer info 352; set expiration date 353; encrypt username and password and serial numbers 354; encrypt license key file 355; key request 356; select bundles 357; reject request 358; reject request 359; enter consumer info 360; enter expiration date and grace period 362; select serial number files 363; Secure System certificate 345; Secure System bundle 364; and Secure System license key file 365.

When a key request is initiated the user is presented with an input folder browser for selecting a bundle for which to issue a license key. The corresponding Secure System certificate is retrieved and the certificate's authenticity is validated. If the certificate can not be found, or if the certificate has been tampered with, then a license key can not be generated. The fields of the certificate employ a one-way encryption to detect attempts to falsify or modify a certificate. Next the distributor identity of the Secure System files contained in the selected bundle is matched to the distributor identity of the certificate. This is done to prevent someone from generating a valid certificate for someone else's bundle. If the owner of the certificate is not the owner of the bundle then a license key can not be generated.

Once the key request has been validated then the consumer identity, expiration date and grace period, license type, and some form of authenticating the licensed users of consumer organization are provided. Either a read-only or an edit license may be specified. The license may be limited to expire on some specified date. Optionally a grace period may be specified to augment the expiration date. The license may be tied to individual hardware serial numbers at the consumer's organization, and/or to username/pas sword authentication. If a username/password is specified this serves as a public key for unlocking the Secure System file. This key is coupled with a private key and both are required to unlock the Secure System file.

The license key preferably employs a one-way encryption involving a random-length, random-generated seed to secure all of the fields of the key. Each field is encrypted separately and in various combinations. The combination of the encrypted fields is preferably stored as a random length, continuous code, typically several hundreds characters long. This is done to prevent forging of Secure System keys. The distributor's identity, the consumer's identity, the expiration date and grace period, a list of consumer hardware serial numbers, username and password, the creation date of the bundle, the creation date of the certificate, and the name and size of each encrypted Secure System file are preferably all included in the key.

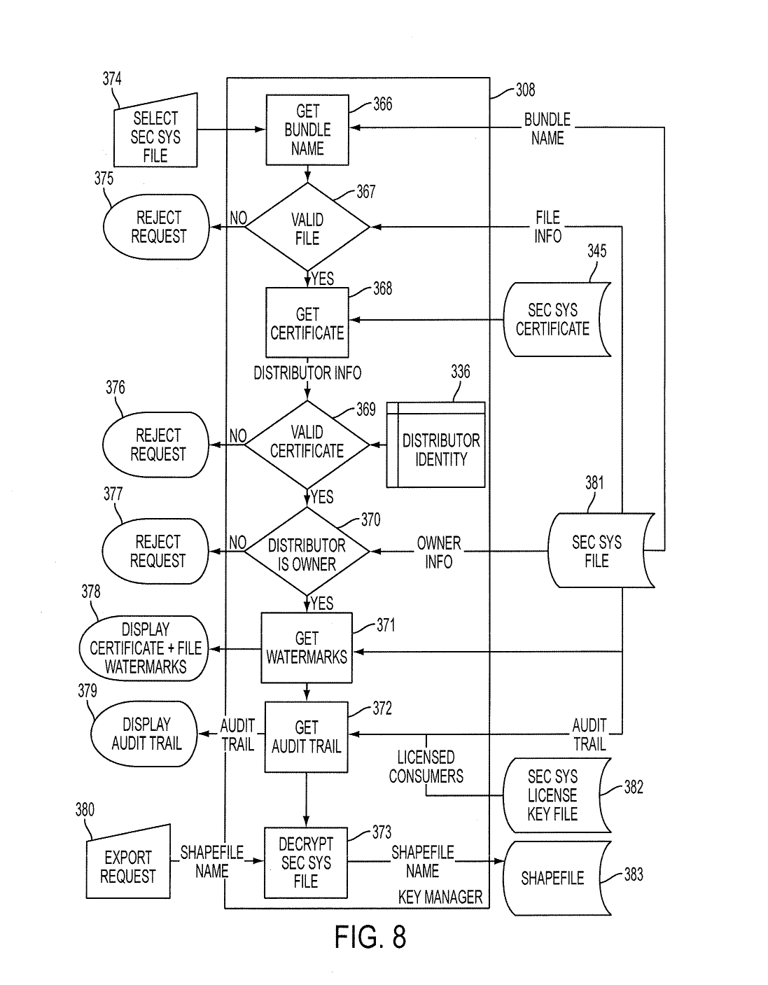

The administration of Secure System files will now be discussed. A set of tools is provided for administering Secure System files. These tools enable a distributor to certify the authenticity of a Secure System file and audit the custody chain of a Secure System file as illustrated in FIG. 8. As shown in FIG. 8, the process of license key creation makes use of the following modules to supply input data, perform processing and/or receive output data: get bundle name 366; valid file determination 367; get certificate 368; valid certificate determination 369; distributor is owner determination 370; get watermarks 371; get audit trail 372; decrypt Secure System file 373; select Secure System file 374; reject request 375; reject request 376; reject request 377; display certificate and file watermarks 378; display audit trail 379; export request 380; Secure System certificate 345; secure System file 381; Secure System license key file 382; and shapefile 383.

This set of tools is initiated by selecting a Secure System file from a file browser. The bundle name is extracted from the selected Secure System file and the file is validated. Any evidence of tampering that is detected results in a message that the Secure System file fails authentication. Tampering can be detected because the Secure System file is preferably secured using one-way encryption of fields that reflect the state of the file under normal usage.

Next, an attempt is made to locate a certificate for the selected Secure System file. Again the certificate is validated using the one-way encrypted fields to detect evidence of tampering. This is done to prevent forging of a certificate for the Secure System file. Also, the distributor identity of the certificate is matched to the distributor identity of the Secure System file. Only the owner of the Secure System file is authorized to examine the Secure System file with the administration tools. An audit trail is produced of the reconstructed custody chain. For each modifier of the Secure System file, the consumer identity and date of the modification are displayed along with the date the license was issued by the distributor of the Secure System file.

Optionally, the certified owner of the selected Secure System may decrypt the Secure System file and export the contents to an ESRI Shapefile. This provides the mechanism for a data consumer to provide updates to the data distributor for incorporation into a new version of the GIS information and maintains the chain of custody for the update. Only the owner of the data may provide edit privileges for the Secure System file and only the owner of the data may revise the source data that produced the Secure System file.

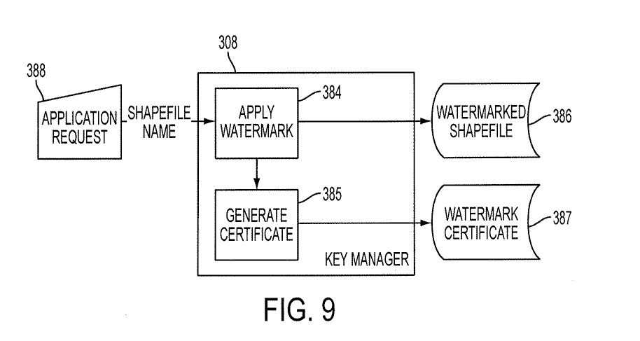

Now the process of watermarking shapefiles will be discussed. A capability is provided to apply a watermark to individual Shapefiles. A schematic view of a process for applying watermarks to shapefiles is shown at FIG. 9, which process of applying a watermark makes use of the following modules to supply input data, perform processing and/or receive output data: apply watermark 384; generate certificate watermarked shapefile 386; watermark certificate 387; and application request 388. While the public token in this example takes the form of a watermark, there are other ways to associate a public token with a file according to the present invention.

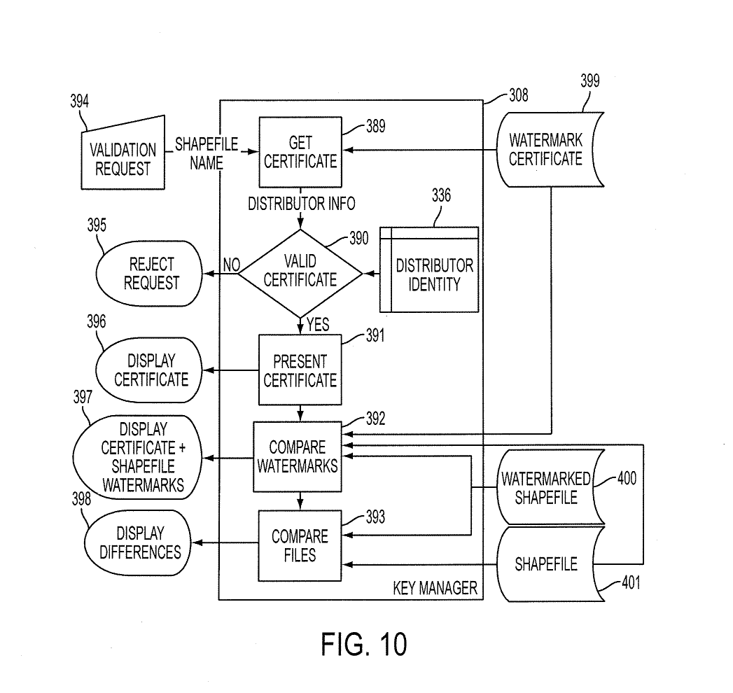

The public token of the shapefile (or the entire shapefile in embodiments where the public token takes the form of a watermark) is archived as a record of authenticity. A the creation and association of the public token with its shapefile is initiated, as illustrated in FIG. 10, by specifying a shapefile with which to associate a public token. In this example, the public token is embedded into the shapefile as a watermark. The original shapefile is also archived. The private key portion of the distributor identity (maintained internally by the Secure System) is applied as a password/secret key for the shapefile with the information being added to a private token stored in the user organization's computer system. In this way, the user system keeps track of which data files the organization has received authorization (for example, purchased a license) to use. In some embodiments, the user organization's computer system may also track limitations on authorization to use data files on a file-by-file basis. For example, the user organization may be licensed to use the Secure System software until some first date in the future, but may only be licensed to use some given shapefile until some second date in the future, with the second date being sooner than the first date. The owner of the shapefile is encoded into the public token and the private token. For example, if the public and private tokens are maintained as shapefile watermarks, then this information will be included in the public and private tokens by virtue of being included in the watermarks of the stored copies of the shapefile.

FIG. 10 shows a process for validating a public token (in the form of a watermark) associated with a shapefile, which process of validating a watermark makes use of the following modules to supply input data, perform processing and/or receive output data: get certificate 389; valid certificate determination 390; present certificate 391; compare watermarks 392; compare files 393; distributor identity 336; validation request 394; reject request 395; display certificate 396; display certificate and shapefile watermarks 397; display differences 398.

III. Secure System Toolbar

The Secure System toolbar preferably provides three major functions as will now be discussed. The first major function is the ability to unlock Secure System files. Authorized users may load decrypted Secure System feature sets into memory for display and analysis by ESRI ArcGIS. Depending on the license key type they may also be able to modify the Secure System feature. The second major function is the ability to manipulate Secure System feature sets. When Secure System features are involved in operations that result in permanent results the results of this analysis is converted to a Secure System file. The distributor's identity, the distributor's ownership, and the custody chain are maintained for the resulting Secure System file. The third major function is optional. If the data distributor has licensed the Secure System file for edit, the ability to modify the underlying shape and attributes of the Secure System file. The custody chain records the modifications made to the Secure System file.

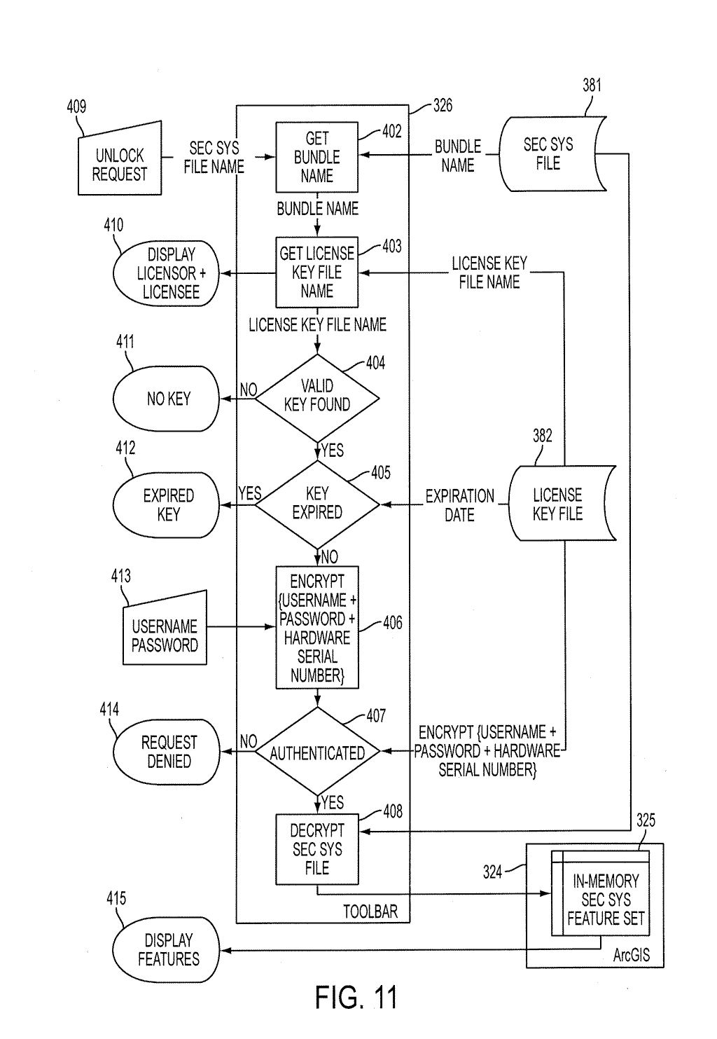

The process of unlocking Secure System files will now be discussed. FIG. 11 shows a process for unlocking a Secure System file, which process of unlocking a Secure System file makes use of the following modules to supply input data, perform processing and/or receive output data: get bundle name 402; get license key file name 403; valid key found determination 404; key expired determination 405; encrypt username and password and hardware serial number 406; authenticated determination 407; decrypt Secure System file 408; unlock request 409; display licensor and licensee 410; no key 411; expired key 412; username password 413; request denied 414; display features 415; Secure System file 381; license key file 382; and ArcGIS 324.

The Secure System toolbar must be loaded in ArcGIS to unlock a Secure System file. The ArcGIS add data function does not recognize a Secure System file as a valid GIS feature set and will not open a Secure System file. When the unlock button is activated on the Secure System toolbar, the user is presented with a file browser to select a Secure System file to add to ArcGIS. The bundle name is extracted from the Secure System file and an attempt is made to locate a corresponding license key. If a license key can not be found or if the license key fails to validate the Secure System file, it can not be opened. If a license key is found, the distributor's organization and the consumer's organization are displayed. The public portion of the distributor's identity (embedded in the Vector Lock file) must match the public portion of the distributor's identity (embedded in the license key) or the search for a license file key will fail.

The private portion of the consumer's identity (embedded in the Secure System software) must match the public portion of the consumer's identity (embedded in the license key) for the license key to be valid. Secure System checks the expiration date and grace period. If the key has expired but the grace period has not been exceeded, the user is notified that the license key has expired and needs to be re-issued or the Secure System file will no longer open. If both the expiration date and the grace period have been exceeded, the Secure System file will not open. The use of a grace period by the data distributor is optional.

Next, the user is authenticated against a hardware serial number and/or a username/password. If a hardware serial number is used it must have been provided to the data distributor when the license key as generated. The hardware serial number in the license key is protected with a one-way encryption employing a random-sized, random-generated seed to initiate the encryption. This is done to prevent an unauthorized user from changing a hardware serial number to enable a license key. If specified, a username/pas sword is protected in a similar fashion in the license key. In either case, an additional private key is required to unlock a Secure System file. The public keys (hardware serial number, username and password) are bound to the private key.

If an unlock request of a valid Secure System file is made by an authorized, and authenticated user, the Secure System file is decrypted and loaded as a memory-resident Secure System feature set either for Read-Only or for Edit, depending on the license type provided by the key.

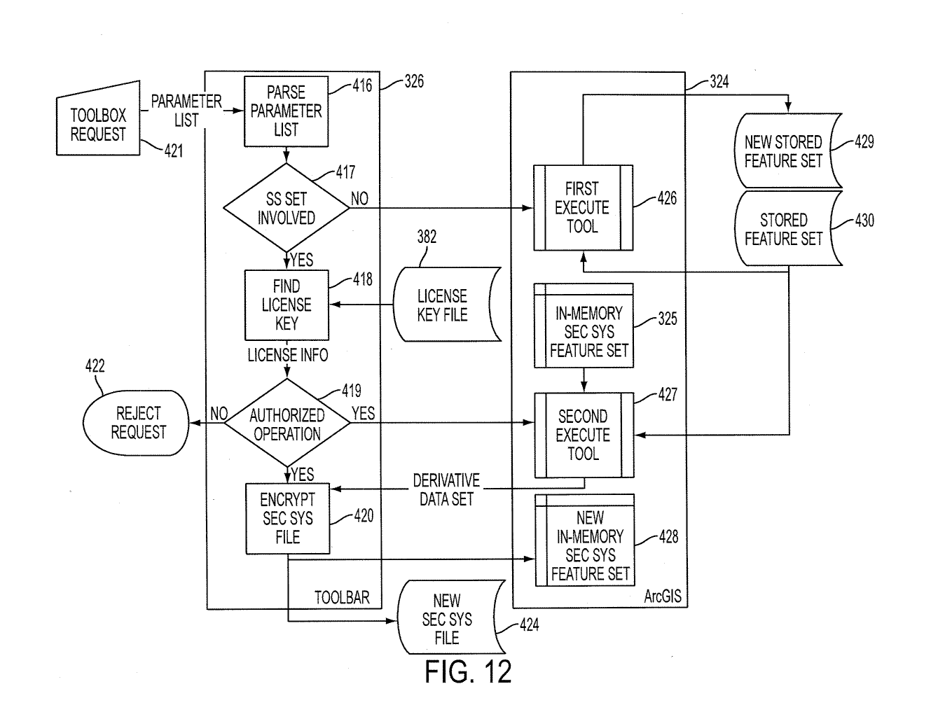

Manipulation of Secure System files will now be discussed. ArcGIS provides a rich function set for analyzing and manipulating GIS data. Many of these functions provide an avenue for saving or exporting feature sets. For this reason, the Secure System toolbar resides between the user and ArcGIS, it handles these events and overrides the normal behavior as appropriate. FIG. 12 provides an illustration of how the tool box functions are handled, and makes use of the following modules to supply input data, perform processing and/or receive output data: parse parameter list 416; Secure System set involved 417; find license key 418; authorized operation determination 419; encrypt Secure System file 420; tool box request 421; reject request 422; license key file 382; new Secure System file 424; first execute tool 426; in-memory Secure System feature set 325; second execute tool 427; new in-memory Secure System feature set 428; new stored feature set 429; and stored feature set 430.

When a tool box request is initiated the event is handled by the Secure System toolbar. The parameter list of the initiated tool is parsed to determine if any Secure System feature sets are involved. If no Secure System feature sets are involved then the execution of the tool continues as normal with the results stored in the specified feature sets; however, if a Secure System feature set is involved, the Secure System toolbar encrypts the results into a new Secure System file instead. The resulting Secure System file will be located in the same folder with the same name as would normally be created. For each Secure System file involved in the tool box operation an attempt is made to locate the corresponding license key. If a key can not be found, if any of the keys is expired, or if any of the keys fail to validate the tool box operation is canceled. If the tool box operation requires an edit license key, then all of the keys must provide edit privileges or the tool box operation is canceled. If the tool box operation produces a result that is not supported by the Secure System format then the tool box operation is canceled.

If the tool box operation can be executed then the results are encrypted into a new Secure System file and the resulting Secure System feature set is added to the ArcGIS memory-resident features. The distributor identity and custody chain of all of the input Secure System feature sets is merged into the new Secure System file that encrypts the derivative data set. If multiple distributors are involved, then the resulting Secure System file will require multiple keys to re-open the Secure System file and access is limited to the most restrictive license type of any of the keys.

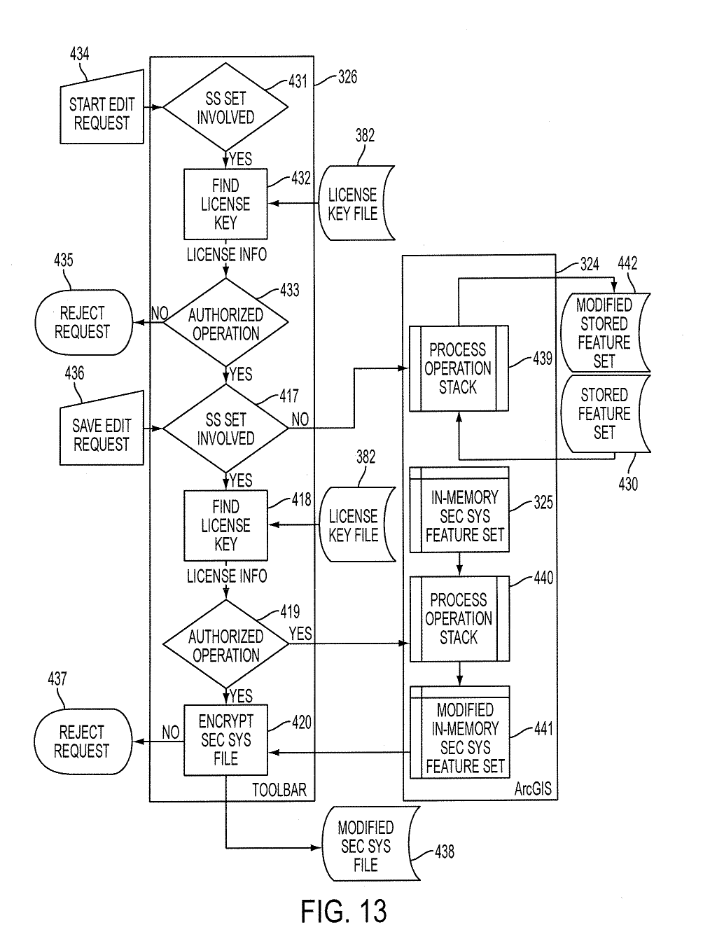

Modification of Secure System files will now be discussed. The Secure System toolbar resides between the user and ArcGIS. It handles edit events and overrides the normal behavior as appropriate. FIG. 13 provides an illustration of how the edit functions are handled, and makes use of the following modules to supply input data, perform processing and/or receive output data: Secure System set involved determination 431; find license key 432; authorized operation determination 433; Secure System set involved determination 417; find license key 418; authorized operation determination 419; encrypt Secure System file 420; start edit request 434; reject request 435; save edit request 436; reject request 437; license key file 382; modified Secure System file 438; process operation stack 439; in-memory Secure System feature set 325; process operation stack 440; modified in-memory Secure System feature set 441; modified stored feature set 442; stored feature set 430.

When a Start Edit request is initiated the Secure System toolbar checks to determine if a Secure System feature set is involved. If not then the edit session is executes normally. If a Secure System feature set is involved then an attempt is made to locate the corresponding license key. If a key can not be found, if the key is expired, if the key fails to validate, or if the key does not provide edit privileges the edit operation is canceled. Otherwise the edit session is initiated and the Secure System toolbar monitors the edit operation stack ensuring that any data added to the active edit session is for authorized, valid Secure System features. If an attempt is made to merge data from a second distributor's Secure System feature set that has not authorized for edit then that operation is not inserted into the edit operation stack.

When a Save Edit request is initiated the Secure System toolbar checks to determine if a Secure System feature set is involved. If not then the edit session is saved normally. If a Secure System feature set is involved then an attempt is made to locate the corresponding license key. If a key can not be found, if the key is expired, if the key fails to validate, or if the key does not provide edit privileges the edit operation is canceled. Otherwise the edit operation stack is processed and the specified Secure System feature set is revised with the pending modifications on the edit operation stack.

If the Save Edit operation can be executed then the results are encrypted into the corresponding Secure System file and the resulting, modified Secure System feature set is updated to the ArcGIS memory-resident features. The distributor identity and custody chain of all of the input Secure System feature sets is merged into the modified Secure System file. If multiple distributors are involved, then the resulting Secure System file will require multiple keys to re-open the Secure System file and access is limited to the most restrictive license type.

### DEFINITIONS

Any and all published documents mentioned herein shall be considered to be incorporated by reference, in their respective entireties, herein to the fullest extent of the patent law. The following definitions are provided for claim construction purposes:

Present invention: means at least some embodiments of the present invention; references to various feature(s) of the “present invention” throughout this document do not mean that all claimed embodiments or methods include the referenced feature(s).

Embodiment: a machine, manufacture, system, method, process and/or composition that may (not must) meet the embodiment of a present, past or future patent claim based on this patent document; for example, an “embodiment” might not be covered by any claims filed with this patent document, but described as an “embodiment” to show the scope of the invention and indicate that it might (or might not) covered in a later arising claim (for example, an amended claim, a continuation application claim, a divisional application claim, a reissue application claim, a re-examination proceeding claim, an interference count); also, an embodiment that is indeed covered by claims filed with this patent document might cease to be covered by claim amendments made during prosecution.

First, second, third, etc. (“ordinals”): Unless otherwise noted, ordinals only serve to distinguish or identify (e.g., various members of a group); the mere use of ordinals shall not be taken to necessarily imply order (for example, time order, space order).

Electrically Connected: means either directly electrically connected, or indirectly electrically connected, such that intervening elements are present; in an indirect electrical connection, the intervening elements may include inductors and/or transformers.

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, quick-release connections, latches and/or magnetic connections), force fit connections, friction fit connections, connections secured by engagement caused by gravitational forces, pivoting or rotatable connections, and/or slidable mechanical connections.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (ii) in a single proximity within a larger piece of software code; (iii) located within a single piece of software code; (iv) located in a single storage device, memory or medium; (v) mechanically connected; (vi) electrically connected; and/or (vii) connected in data communication.

vector file format data file: a data file that includes spatial, or visual information as parameters, or what is commonly called vectors; for example, points, curves, proportions, dimensions (absolute or relative) may be used as raw data to build graphic displays based on the vector file format data file; vector file format data files are different than raster, or bitmap, based image files because these use pixel information (2D or 3D) to make an image rather than vector information; two examples of vector file format data files are most computer aided design files (“CAD files”) and shapefiles; vector file format data files may include raster information and/or text based information in addition to their vector file format data, but must include some substantial vector file format data to be considered as vector file format data files.

vector file format only data file: vector file format only data files are vector file format data files that do not include any substantial raster information in addition to their vector file format data, but may include some text based information.

accessed: except where context clearly indicates otherwise, accessed means accessed and/or processed; for example, creating modifying a pre-existing file is herein considered as a form of accessing a file; for vector file format data files, accessing will generally involve creating some sort of visual display based on at least a portion of the vector file format data present in the file.

file: a single file or a set of related files; files may include executable instruction data, presentation data (for example still image bitmap data, compressed still image bitmap data, video data, compressed video data, audio data, compressed audio data or the like) or a combination of executable instruction data and presentation data; code-based watermarking can only be applied to files (or sets of files) that include at least some executable instruction data because the code-based watermark must be applied (at least in part) to executable instruction data.

license: any operative set of rules controlling authorization to use computer code (such as a piece of software or a data file); the “license” may be based upon intellectual property rights (such as, patent, copyright or trade secrets law), or it may be based strictly upon private ordering; the license need not be written; the “license” as that term herein may be in the form of a license, an assignment, a sale, a lease, a writ of permission, or any other legal form (now known or to be developed in the future) that is used to determine authorization to utilize a piece of computer code.

To the extent that the definitions provided above are consistent with ordinary, plain, and accustomed meanings (as generally shown by documents such as dictionaries and/or technical lexicons), the above definitions shall be considered supplemental in nature. To the extent that the definitions provided above are inconsistent with ordinary, plain, and accustomed meanings (as generally shown by documents such as dictionaries and/or technical lexicons), the above definitions shall control.

Unless otherwise explicitly provided in the claim language, steps in method steps or process claims need only be performed in the same time order as the order the steps are recited in the claim only to the extent that impossibility or extreme feasibility problems dictate that the recited step order be used. This broad interpretation with respect to step order is to be used regardless of whether the alternative time ordering(s) of the claimed steps is particularly mentioned or discussed in this document—in other words, any step order discussed in the above specification shall be considered as required by a method claim only if the step order is explicitly set forth in the words of the method claim itself. Also, if some time ordering is explicitly set forth in a method claim, the time ordering claim language shall not be taken as an implicit limitation on whether claimed steps are immediately consecutive in time, or as an implicit limitation against intervening steps.

What is claimed is:

1. A computer system for accessing files, the system comprising:
a set of computer(s) comprising at least one computer, the set of computers comprising:
a first hardware-identification code,
a processing module, and
a storage module;
wherein:
the storage module is structured, connected and/or programmed to store a copy of the secured-access software;
the processing module is structured, connected and/or programmed to run a copy of the secured-access software;
the secured-access software comprises a private token that indicates: (i) an authorized hardware-identification code of computer equipment upon which the secured-access software is authorized to run; and (ii) an identification of the specific copy of the secured-access software that is stored in the storage module;
the secured-access software is programmed to receive a public token associated with a first file that is being attempted to be accessed through the secured-access software, with the public token indicating a set of identities of authorized copy(ies), including at least one authorized copy, with the set of identities of authorized copy(ies) corresponding to the specific copy(ies) of the secured-access software with which the first file is authorized to be accessed;
the secured-access software is further programmed to check a first condition where the private token is checked against the first hardware-identification code to determine whether the authorized hardware-identification code matches the authorized first-identification code;
the secured-access software is further programmed to check a second condition where the private token is checked against the public token to determine whether the identity of the specific copy of the secured-access software stored in the storage module matches at least one of the identities of authorized copy(ies) of the set identities of authorized installation(s) indicated by the public token; and
the secured-access software is further programmed to allow the first file to be accessed by the secured-access software only if both the first condition and second condition are both met.

2. The system of claim 1 wherein the first file is a vector file format data file.

3. The system of claim 2 wherein the first file is a vector file format only data file.

4. The system of claim 2 wherein the public token is stored as a watermark embedded in the first file.

5. The system of claim 2 wherein:
the set of computers comprises an end user computer and a vector file format program server computer.

6. The system of claim 1 wherein:
the first file is encrypted;
the private token includes private decryption key for the first file;
the public token includes a public decryption key for the first file; and
the secured-access software further comprises a decryption module that is structured and/or programmed to decrypt the first files using the private decryption key and the public decryption key.

7. The system of claim 1 wherein:
the secured-access software includes a set of conditions of authorized use including at least one condition of authorized use;
the secured-access software is further programmed to check whether all conditions of authorized use are met; and
the secured-access software is further programmed to allow the first file to be accessed by the secured-access software only if all conditions of authorized use of the set of conditions of authorized use are met.

8. The system of claim 7 wherein a first condition of authorized use of the set of conditions of authorized use corresponds to a designated time period for which use of the secured-access software is licensed.

9. The system of claim 7 wherein a first condition of authorized use of the set of conditions of authorized use corresponds to a designated time period for which use of the first file is licensed.

10. A method of accessing files by a computer system including a first hardware-identification code, a processing module, and a storage module, the method comprising the steps of:
providing, on the computer system, secured-access software including a private token that indicates: (i) an authorized hardware-identification code of computer equipment upon which the secured-access software is authorized to run; and (ii) an identification of the specific copy of the secured-access software;
receiving, by the secured-access software, a public token associated with a first file that is being attempted to be accessed through the secured-access software, with the public token indicating a set of identities of authorized copy(ies), including at least one authorized copy, with the set of identities of authorized copy(ies) corresponding to the specific copy(ies) of the secured-access software with which the first file is authorized to be accessed;
checking, by the secured access software, a first condition where the private token is checked against the first hardware-identification code to determine whether the authorized hardware-identification code matches the authorized first-identification code;
checking, by the secured-access software, a second condition where the private token is checked against the public token to determine whether the identity of the specific copy of the secured-access software matches at least one of the identities of authorized copy(ies) of the set of identities of authorized copy(ies) indicated by the public token; and
allowing access, by the secured-access software, to the first file only if both the first condition and second condition are determined to be met at the two checking steps.

11. The system of claim 10 wherein the first file is a vector file format data file.

12. The system of claim 11 wherein the first file is a vector file format only data file.

13. The system of claim 10 wherein the public token is stored as a watermark embedded in the first file.

14. The system of claim 11 wherein:
the set of computers comprises an end user computer and a vector file format program server computer.

15. The system of claim 10 wherein:
the first file is encrypted;
the private token includes private decryption key for the first file;
the public token includes a public decryption key for the first file; and
the accessing step comprises the sub-step of decrypting the first files using the private decryption key and the public decryption key.

16. The system of claim 11 wherein the accessing step comprises the sub-step of creating a visual display corresponding to at least a portion of the vector file format data in the vector file format data file.

17. The system of claim 10 wherein:
the secured-access software includes a set of conditions of authorized use including at least one condition of authorized use;
check, by the secured-access software, whether all conditions of authorized use of a set of conditions of authorized use (including at least one condition of authorized use) are met; and
allowing, by the secured-access software, the first file to be accessed by the secured-access software only if all conditions of authorized use of the set of conditions of authorized use are met.

18. The system of claim 17 wherein a first condition of authorized use of the set of conditions of authorized use corresponds to a designated time period for which use of the secured-access software is licensed.

19. The system of claim 17 wherein a first condition of authorized use of the set of conditions of authorized use corresponds to a designated time period for which use of the first file is licensed.

20. A method of providing a file for authorized use, the method comprising the steps of:
providing the file to a file securing computer;
associating, by the file securing computer, the file with a public token including a public decryption key;
encrypting, by the file securing computer, the file based at least in part upon public decryption key; and
providing the encrypted file and its associated public token to an end user computer;
wherein:
the public token further includes a set of identities of authorized copies of file processing software corresponding to the identities of specific copies by which the file is authorized to be accessed.
